(19) United States
(12) Patent Application Publication
(10) Pub. No.: US 2010/0219254 A1
(43) Pub. Date: Sep. 2, 2010

(54) Air Navigation Computer

(76) Inventor: Andrew Gilbert Fry, Melbourne (AU)

Correspondence Address: Dr. Andrew Fry, 25A Arden Street, North Melbourne, 3051, AU

(21) Appl. No.: 12/395,728

(22) Filed: Mar. 2, 2009

(51) Int. Cl. G06C 27/00

(52) U.S. Cl. 235/78 N

(57) ABSTRACT

The disclosed aviation navigation instrument is a flight computer for solving wind triangle problems by moving plots of crosswind and crosstrack component speeds to balance drift with crosswind. The instrument incorporates a base 50 which provides an indication of direction and various plates movable about the direction axis, the plates being transparent so the operator may read and compare the plots marked on the plates. Wind plate 40 is marked with a number of crosswind plots that indicate the crosswind component of given wind speeds over the full range of directions. Heading plate 20 is marked with a number of crosstrack plots that indicate crosstrack component of a given airspeed over a range of directions. Track plate 30 is marked with effective airspeed plots that indicate the effective airspeed for given airspeeds over a range of directions. The various plates incorporate indications of each plot's origin, and scales for reading opposing plots.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention pertains to aircraft navigation and specifically to solving wind triangle problems.

To plan each sector of a flight, an aircraft pilot or navigator must know the direction to fly allowing for any drift caused by wind (the “heading” direction), and the aircraft's speed with respect to the ground (the “groundspeed”). The pilot or navigator calculates heading and groundspeed knowing the direction from one waypoint to the next (the “track” direction), aircraft's cruising speed through the air (“airspeed”), and the speed and direction of the wind. These calculations are known as “wind triangle” problems after the vector addition method commonly used to find a solution. Pilots are required to solve wind triangle problems without recourse to electronic calculators because such devices may not be available under adverse conditions.

Existing instruments for solving wind triangle problems are based on either explicit vector addition (the E6-B style devices, e.g. U.S. Pat. No. 3,350,007) or on calculations from basic trigonometric ratios (the CR-6 style devices, e.g. U.S. Pat. No. 2,775,404). The E6-B requires marking the wind vector on the instrument face and performing a sequence of readings and basic arithmetic operations. The CR-6 style instruments requires the user to perform rather more readings and arithmetic operations. Considerable care and practice must be taken to prevent error, especially under adverse or in-flight conditions.

Instruments of both styles are normally manufactured as the reverse side of a conventional circular slide rule that is used to solve time/distance/speed problems and to convert between various units of measure.

To solve a wind triangle problem using an E6-B style instrument, the operator draws a vector representing wind velocity and direction on the faceplate of the instrument, aligns the base-plate to the aircraft's airspeed so the wind vector adds to the aircraft vector, and rotates the faceplate so the wind vector is correctly aligned relative to the desired track. The operator can then read the aircraft's ground-speed from a scale on the instrument, and also reads a “correction angle” that must be added or subtracted from the desired track to allow for drift. Finally, the wind vector is erased from the faceplate ready for planning the next flight sector.

To solve a wind triangle problem using a CR-6 style instrument, the operator finds the wind vector on the instrument's faceplate and reads the effective crosswind velocity and the headwind velocity. An alternative scale permits the “correction angle” to be calculated from airspeed; the correction angle is added or subtracted from the desired track to allow for drift. Both correction angle and airspeed are applied to a separate slide-rule scale which calculates an “effective airspeed” that allows for the effect of drift angle. Finally, the previously read headwind or tailwind is added to or subtracted from the effective airspeed, giving the actual ground-speed.

### BRIEF SUMMARY OF THE INVENTION

As described above, a problem in aircraft navigation is, given specific wind direction, wind velocity, aircraft airspeed and required track, to find the aircraft heading which will fly the required track and to find the aircraft's resulting groundspeed. Further, the reverse problem is to find the actual wind direction and wind speed knowing aircraft heading, airspeed, track and groundspeed. It is an object of this invention to permit an aircraft pilot or navigator quickly, with sufficient accuracy, and with minimum manipulation or mental calculation, to find the aircraft heading which produces the desired track under specified conditions. It is a further object of this invention to permit a pilot or navigator to quickly and with appropriate accuracy determine the actual wind from information available during flight.

Existing instruments are based on either vector arithmetic or trigonometric ratios. E6-B style instruments operate by explicit vector arithmetic, simplified by some shortcuts. CR-6 style instruments operate by reading scales showing the basic trigonometric ratios and performing simplified calculations based on products of these ratios. Instead, this invention operates by allowing the user to compare and manipulate plots of crosswind and crosstrack speeds and to adjust heading direction such that the crosswind and crosstrack components are balanced. Further, this instrument is based on a compass rose (a circular scale of directions) from which the result of adjustments are read naturally, rather than requiring additional mental arithmetic.

The invention shows plots of crosswind component speed against direction (the crosswind component is the portion of the wind acting perpendicular to the aircraft's track) and crosstrack component speed against direction (crosstrack component being the portion of aircraft's airspeed acting perpendicular to the aircraft's track). The invention allows for direct comparison of these components. By adjusting aircraft heading, the operator balances the opposing crosswind and crosstrack components and so finds the heading that will produce the desired track. The invention incorporates additional scales that allow the operator to read effective airspeed (the portion of the aircraft's airspeed acting along the aircraft's track) and to read the headwind or tailwind component of the wind. Adding tailwind to effective airspeed (or subtracting headwind from effective airspeed) gives groundspeed. Thus by balancing the two plots and performing one arithmetic calculation, a pilot or navigator can quickly obtain the information required to plan each flight sector.

The invention can also be used in the reverse sense to solve the opposite problem of finding actual wind speed and direction from information observed from the aircraft in flight.

### BRIEF DESCRIPTION OF THE SEVERAL VIEWS OF THE DRAWING

FIG. 1 shows the arrangement of the plates making up the preferred embodiment of the invention.

FIG. 2 shows details of base plate 50 and compass rose 51 used to indicate direction.

FIG. 3 shows details of wind plate 40 used to specify the wind direction and plots 42, 33, 44 indicating crosswind component.

FIG. 4 shows details of track plate 30, which is used to locate the track where crosswind and crosstrack components are balanced. The track plate 30 is also marked with effective airspeed plots 33, 34 and a scale 32 for reading headwind or tailwind speed.

FIG. 5 shows details of heading plate 20 that shows crosstrack component plots 23, 24 and is also marked with a scale 21 for reading effective airspeed.

FIG. 6 shows the method of reading the instrument.

FIG. 7 shows a section through central axis of the preferred embodiment of the invention.

FIG. 8 shows an alternative construction as a straight slide rule.

### DETAILED DESCRIPTION OF THE INVENTION

The invention is primarily distinguished from prior art by the use of two movable plots displayed on wind plate 40 and heading plate 20 showing respectively speed of crosswind component of wind against direction, and speed of crosstrack component of aircraft speed against direction. Each plot may be moved so its origin is aligned to any desired direction. A useful property is that the crosswind and crosstrack components are balanced at the intersection of the two plots and so the aircraft's track corresponds to the direction at which this occurs.

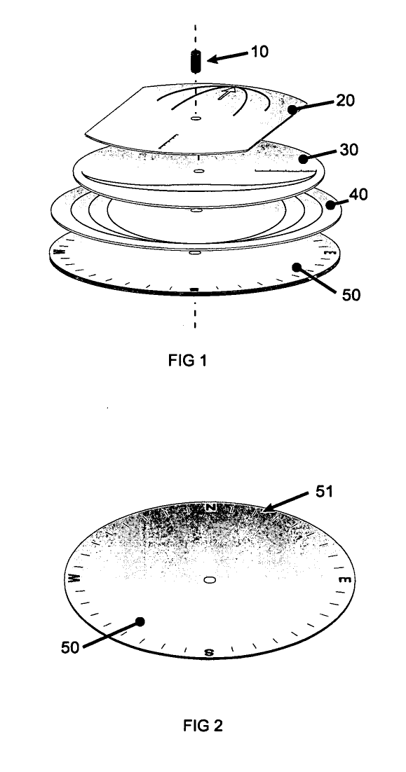

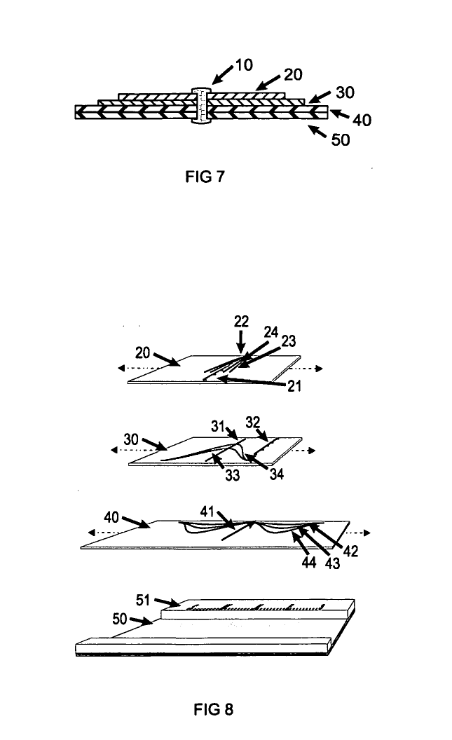

The invention consists of an axle 10, base plate 50, wind plate 40, track indictor 30 and heading plate 20 arranged as shown in FIG. 1 and FIG. 7. Axle 10 is permits plates 20, 30, 40 and 50 to rotate with respect to each other while remaining centred.

The base plate 50, see FIG. 2, is a disk that provides an indication of direction by means of a compass rose 51.

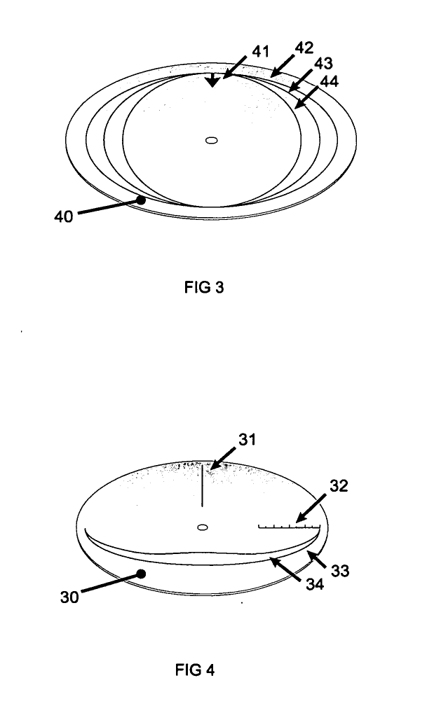

The wind plate 40, illustrated in FIG. 3, is a disk of similar radius to base plate 50 and is transparent so the operator may easily see compass rose 51. Wind plate 40 may be rotated on axle 10 to any desired direction. Wind arrow 41 represents the direction from which the wind is blowing and corresponds with the origin of the crosswind plots at direction 0°. Wind plate 40 is marked with a number of crosswind plots 42, 43 and 44 that indicate the crosswind component of given wind speeds over the full range of directions. Crosswind component speed is represented as distance inwards from arbitrary radius R on some convenient scale S. Radius R is centred about axle 10. Crosswind plots 42, 43 and 44 are marked such that distance inwards from R at direction d for wind speed W is abs(W×S×sin(d)).

Track plate 30, shown in FIG. 4, is a transparent disk of slightly smaller radius than plates 50 and 40 which permits the operator to fix the wind direction of plate 40 while still rotating track plate 30 to align marked track radial 31 to any desired direction. Radial 31 corresponds to the plot origin at direction 0°. The operator may view wind plate 40 through track plate 30. Headwind scale 32 is located 90° from radial 31, drawn at scale S inwards from radius R such that the operator can read the value of crosswind plots 42, 43 and 44 at the nominated direction; the crosswind at 90° off-track being the headwind or tailwind. Track plate 30 is marked with effective airspeed plots 33 and 34 that indicate the effective airspeed of a vehicle travelling at given airspeeds over a range of directions. Effective airspeed for airspeed A is represented as distance inwards from arbitrary radius R on scale T as given by abs(A×T×cos(d)), where scales T and S may be the same or different.

The heading plate 20, illustrated in FIG. 5, is a disk of similar diameter to track plate 30 with one or more portions 25 removed so the operator may, while holding plates 50, 40 and 30 fixed, rotate heading plate 20 on axle 10, aligning plate 20 to any desired direction. Heading plate 20 is transparent so the operator may view wind plate 40 and track plate 30. A heading arrow 22 is provided for ease of reading the heading and corresponds to direction 0°. Heading plate 20 is marked with a number of crosstrack plots 23 and 24 that indicate crosstrack component of a given airspeed over a range of directions. Crosstrack component is represented as distance inwards from radius R at said scale S. Crosstrack speed plots 23 and 24 are marked such that distance from radius R at direction d for airspeed A is given by abs(A×S×sin(d)). An effective airspeed scale 21 is marked at the 180° direction according to scale T.

For ease of use, effective airspeed plots 33 and 34 and effective airspeed scale 21 are marked in a colour that contrasts with the other plots and scales, so the operator applies the appropriate scale to each plot.

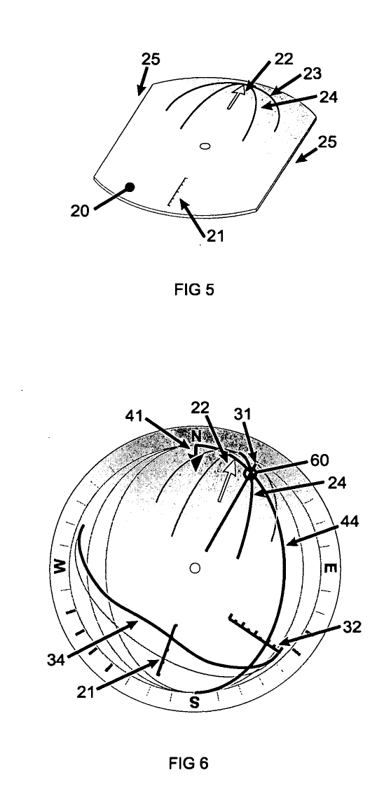

A useful property of the invention is illustrated in FIG. 6. In this example the wind is from the north, the desired track is 030°, the wind speed corresponds to the inner-most wind speed plot, and the vehicle's airspeed corresponds to the inner-most airspeed plot. The intersection 60 of a crosswind trace 44 with a crosstrack trace 24 occurs where crosswind component and crosstrack component are equal, corresponding to the vehicle's track; the vehicle's heading (020°) is easily read at heading arrow 22. The headwind or tailwind can be read at scale 32 and subtracted from the effective airspeed read at scale 21, giving the vehicle's groundspeed.

To calculate the heading which produces some specified track, the operator:
aligns wind arrow 41 with the expected wind direction on base plate 50,
aligns track radial 31 with the desired track on base plate 50,
locates the point 60 where the applicable wind speed trace 44 intersects with track radial 31,
aligns heading plate 20 such that the applicable airspeed trace 24 also intersects with radial 31 at the same point 60 (potential ambiguity is resolved by always aligning heading arrow 22 closer to wind arrow 41), see FIG. 6,
reads the heading to fly from heading arrow 22,
reads the effective airspeed from airspeed plot 34 using scale 21,
subtracts headwind read from scale 32 from (or adds tailwind to) the effective airspeed to obtain the ground speed.

To perform the reverse calculation, finding the actual wind from known heading, track and groundspeed, the operator:
sets heading arrow 22 to the heading flown,
sets track arrow 31 to the track observed,
reads the effective airspeed from scale 21 and calculates the component headwind (tailwind), being the difference between observed groundspeed and effective airspeed,
fixing heading plate 20 with respect to track plate 30, rotates wind plate 40 so that the wind speed W (plot 42, 43 or 44) that intersects with both track radial 31 and airspeed (plot 22 or 23) is read on scale 32 as the component headwind (or tailwind) calculated in the prior step,
reads wind direction from wind arrow 25 and takes wind speed as said W.

The operator interpolates between marked plots when wind speed or aircraft speed does not correspond to the marked plots.

The instrument may be constructed as the reverse of a conventional circular slide rule used to perform distance/time/speed calculations and various useful conversions.

This invention may be arranged in any variation which produces similarly usable scales. For example, effective airspeed plots 33 and 34 and effective airspeed scale 21 will operate equally correctly if marked on track plate 30 and heading plate 20 respectively.

The invention may alternatively be constructed as a straight slide rule, as shown in FIG. 8, where scales corresponding to the base plate 50, wind plate 40, indicator plate 30, and heading plate 20 are constructed as simple linear scales mounted on plates that slide along a linear axis.

What is claimed is:

1. An aviation navigation instrument incorporating a direction scale, two plates mounted on said direction scale, said plates restrained to move primarily about the direction axis, each plate marked with one or more plots of speed against direction,
each plot indicates the absolute value of the component acting perpendicular to the origin direction of said plot of a vector acting in the plotted direction at said speed,
said plots may be viewed by any means including direct vision, by transparency of the plates, piercings in the plates, or by openings through the plates.

2. An aviation navigation instrument as claimed in claim 1, incorporating a third plate mounted on said direction scale, said plate restrained to move primarily about the direction axis, said plate marked with one or more plots of speed against direction,
each plot indicates the absolute value of the component acting parallel to the origin direction of said plot of a vector acting in the plotted direction at said speed,
said plots may be viewed by any means including direct vision, by transparency of the plates, piercings in the plates, or by openings through the plates.

3. An aviation navigation instrument according to claims 1 or 2, incorporating scales for reading the value of said plots.

4. An aviation navigation instrument according to any one of claims 1, 2 and 3 incorporating indicators of the origin of any said plots.

5. An aviation navigation instrument substantially as herein before described with reference to FIGS. 1-8 of the accompanying drawings.
